(19) United States
(12) Patent Application Publication
(10) Pub. No.: US 2002/0130236 A1
(43) Pub. Date: Sep. 19, 2002

(54) Stand for stemmed glasses

(76) Inventor: Tracey Anne Swensen, Mosman (AU)

Correspondence Address: CARLSON, GASKEY & OLDS, P.C., 400 WEST MAPLE ROAD, SUITE 350, BIRMINGHAM, MI, 48009, US

(21) Appl. No.: 10/092,931

(22) Filed: Mar. 7, 2002

(30) Foreign Application Priority Data
Mar. 17, 2001 (AU) PR3795

(51) Int. Cl. F16M 13/00; A47F 7/00

(52) U.S. Cl. 248/315; 248/530

(57) ABSTRACT

The invention provides a stand for a stemmed drinking implement, such as a wine glass, and in a preferred form provides a stake for insertion into the ground and a support for engaging and supporting the cup of the drinking implement, rather than the base of the drinking implement with the base of the glass raised above the ground. Since the region of support is much nearer to the center of gravity than the base or even above the center of gravity of the drinking implement, the stability of the drinking implement in the stand is much improved compared to merely placing the drinking implement directly on the ground. Provision of a stake permits that the stand can accommodate uneven or sloping ground easily. In one broad form the invention provides a stand for a stemmed glass or the like including a base portion for attachment to or insertion into a relatively stable object and at least one support portion for holding a stemmed glass. The support portion is adapted to engage the cup portion of the glass to hold the glass above the ground in a generally upright position.

### TECHNICAL FIELD

This invention relates to support devices for drinking implements and in particular glasses with stems or stemmed glasses, such as wine glasses.

### BACKGROUND Art

When picnicking one lays out a meal on the ground, which is invariably uneven. This presents problems with drinking implements such as glasses and cups, as the unevenness of the ground means that they are unstable and likely to fall over. Stemmed glasses, such as wine glasses, are particularly susceptible to falling over when placed on uneven ground due to the cup portion being raised a considerable distance above the base and having a diameter roughly equal to that of the base. Accordingly a stemmed glass will fall over at moderate leans to the vertical, such as when placed on uneven ground.

### SUMMARY OF THE INVENTION

The invention provides a stand for a stemmed drinking implement, such as a wine glass, and in a preferred form provides a stake for insertion into the ground and a support for engaging and supporting the cup of the drinking implement, rather than the base of the drinking implement with the base of the glass raised above the ground. Since the region of support is much nearer to the center of gravity than the base or even above the center of gravity of the drinking implement, the stability of the drinking implement in the stand is much improved compared to merely placing the drinking implement directly on the ground. Provision of a stake means that the stand can accommodate uneven or sloping ground easily.

In one broad form the invention provides a stand for a stemmed glass or the like including a base portion for attachment to or insertion into a relatively stable object and at least one support portion for holding a stemmed glass, the support portion adapted to engage the cup portion of the glass at least at three locations and to hold the glass above the ground in a generally upright position.

Preferably the base portion is for insertion into the ground, but may be a clip or the like for attachment to a table or a picnic hamper, although these provide less stability. Preferably the base portion includes at least one elongate stake for insertion into the ground. Preferably there is a single stake portion.

The at least one support portion preferably extends to one side of the base portion but it may be located above the base portion. Where the at least one support portion extends to one side of the base portion, preferably the support portion depends from an upper section of the base portion, preferably the top end of the base portion.

Preferably each stand has only one support portion but there may be two or more support portions. Where there is more than one support portion, preferably each support portion is arranged around the base portion.

The support portion preferably defines at least one engagement surface, preferably in the shape of part of a circle upon which the cup rests. The engagement surface may be in other shapes, such as a part triangle or a part square of other equilateral polygons. A part circle or polygon is defined so that the stem of the glass may be passed through the resulting gap. The engagement surface may be defined by one or more rods or rod like structures. As an alternative, the support portion may be generally planar with a key hole shaped aperture extending through the plane of the material. The narrow portion of the key hole opens on a side of the support portion to allow the stem of the glass to be passed along the narrow portion to the circular portion.

The support surface need not define a continuous surface or series of surfaces upon which the cup rests but may define a series of points instead. Additionally the support surfaces or points need not lie in a common plane. For example a truncated cone like surface open at both ends and having a vertical slot may be used as the support surface. Different points or surfaces may be engaged by different sized glasses. In addition to a primary support surface laying in a plane, there may be a number of support surfaces extending downwards and inwards from the primary support surface(s) to accommodate glasses too small to rest on the primary support surface. Where the primary support surface is a circle, preferably there are at least three supplemental support surfaces. When the primary support surface is a polygon, preferably the number of supplemental surfaces is equal to the number of sides of the polygon. Alternatively the stand may merely have the “supplemental” support surface(s).

The stand is preferably formed of metal and more preferably stainless steel, but other materials, such as plastics may be used.

A preferred form of the invention is a single piece of rod formed into an elongate stake portion at one end and the other end formed into the support portion. The support portion extends sideways from the top of the stake portion and is bent to define a part circle or equilateral polygon. The rod is preferably 304 grade stainless steel and has a diameter of about 6.35 mm (¼ inch).

### BRIEF DESCRIPTION OF THE DRAWINGS

FIG. 1 shows a plan view of a first embodiment of the invention;

FIG. 2 shows a side view of the FIG. 1 embodiment;

FIG. 3 shows a cross section through the embodiment of FIG. 1 in use;

FIG. 4 shows a plan view from above of a second embodiment of the invention;

FIG. 5 shows a side view of the FIG. 4 embodiment;

FIG. 6 shows a plan view from above of a third embodiment of the invention;

FIG. 7 shows a side view of the FIG. 6 embodiment;

FIG. 8 shows a plan view from above of a fourth embodiment of the invention;

FIG. 9 shows a side view of the FIG. 8 embodiment;

FIG. 10 shows a plan view from above of a fifth embodiment of the invention, and

FIG. 11 shows a side view of the FIG. 10 embodiment;

### BEST MODES OF CARRYING OUT THE INVENTION

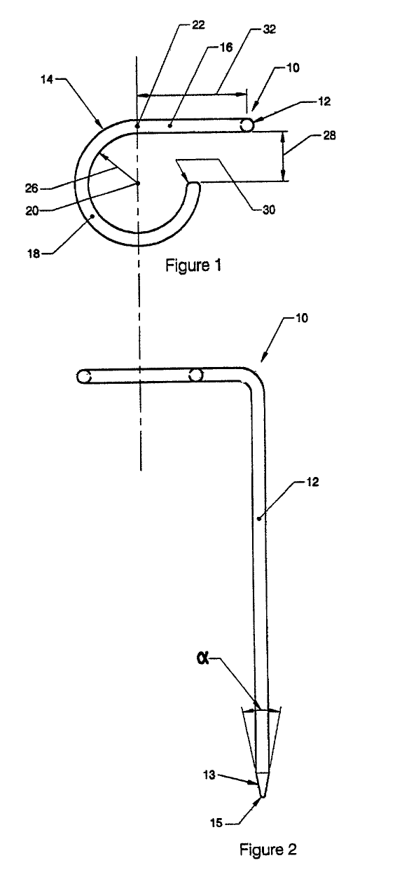

Referring to FIGS. 1 & 2 there is shown a stemmed glass holder 10. The holder is formed of a single piece of rod formed into a stake portion 12 and a support portion 14. The rod is preferably made of 304 grade stainless steel and is of circular cross section. The cross sectional diameter of the rod is preferably about 6.35 mm (¼ inch), but other diameters may be used. Other materials may be used with the same or other rod diameters, depending on the strength of the material. Generally the rod diameter is chosen to provide the stake portion with sufficient strength that it will not bend when driven into stony ground but will be relatively easily bent by a rod bending machine. The diameter of the rod will be determined in part by the length of the stake portion and the strength of the material; a long stake portion will need a larger diameter than a short stake portion, all other factors being the same. The free end 13 of the stake portion 12 is preferably tapered to a tip 15 to aid insertion into the ground. Preferably the angle α is about 20 degrees, but this is not critical. The tip 15 is preferably rounded with a radius of curvature of about 2 mm, but again this is not critical and the tip 15 may be a point. If desired the end 13 need not be tapered and may be cut off square or provided with a rounded end.

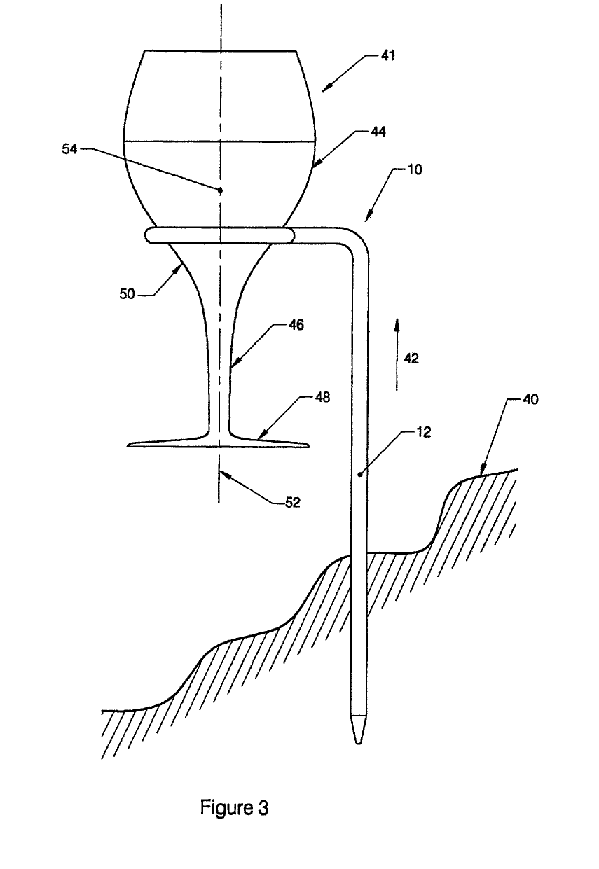

The stake portion is about 250 mm long; this raises the support portion 14 sufficiently high above the ground so that in use (see FIG. 3) a stemmed glass is supported above the ground.

The support portion 14 is comprised of a linear section 16 and a generally arcuate section 18. The linear section extends perpendicular to the stake portion 12 and the arcuate section 18 extends from the end of the linear section, in the plane of the linear section 16, to curve back toward the stake portion. The arcuate portion is preferably centered on a center point 20 which is located in a plane perpendicular to both the stake and linear sections and which extends through or adjacent the end 22 of the linear section. However, the center point 20 may be further away from the stake than the end point 22 from the stake portion or it may be nearer. The center point is also the radius of curvature 26 from the end point, so that the transition from the linear to arcuate sections is smooth. However, if desired, the center point may be more or less than the center of curvature from the linear section. In the preferred embodiment the distance from the center point 20 to the center line of the stake portion 12 is about 57 mm, but this is not critical.

The arcuate section 18 has a radius of curvature of the inside surface of approximately 20 mm to give an inside diameter of 40 mm. With 6.35 mm diameter rod, the radius of curvature of the center line of the rod is thus approximately 23.175 mm. The arcuate section extend less than 360 degrees so as to leave an opening 28 between the second end 30 of the rod and the linear section 16. This opening is about 23 mm wide, measured between the shortest distance from the linear section to the second end 30. The second end 30 is preferably rounded, with a radius of curvature of about 2 mm, and depending on the shape of the second end 30 this shortest distance may be perpendicular to the linear section or slightly off perpendicular. However, as will be explained below, the dimensions of the radius of curvature and the opening 28 are not critical.

The stemmed glass holder 10 is intended to be driven into the ground, with the stake portion 12 substantially upright. Preferably the stake portion is generally vertical relative to the local gravity field, rather than vertical to the local slope of the ground. However, the angle of the stake to the local gravity field may vary significantly from zero without affecting the operation of the device, as will be explained later. The degree to which the stake portion 12 is inserted into the ground depends on the nature of the ground and the nature of the stemmed glass to be supported. Soft ground and/or a heavy glass will generally require the stake portion 12 to be inserted into the ground more than hard ground and/or a light glass.

Referring to FIG. 3 there is shown the stemmed glass holder 10 inserted into the ground 40 and supporting a stemmed glass 41. The stake portion 12 has been driven into the ground 40 to provide sufficient stability but to allow the stemmed glass 41 to rest on the stand with its base 48 clear of the ground. The surface of the ground 40 is uneven and is not perpendicular to the local gravity field, indicated by the arrow 42. The stemmed glass is a typical wine glass and comprises a cup portion 44, a stem 46 and a base 48. The lower section 50 of the cup portion 44 adjacent the stem 46 is roughly spherical or elliptical and in plan view presents a generally circular cross section. Accordingly, the stemmed glass 41 may easily rest on the support section even if the vertical center line 52 of the stemmed glass is not parallel to the stake portion. Thus the stemmed glass may be placed in a generally vertical or near vertical orientation, even if the stake is not exactly vertical.

The center of gravity of a full stemmed glass is shown at 54 and it will be appreciated that tipping of the stemmed glass relative to the stand 10 will generally not result in the center of gravity passing outside the boundaries of the contact line of the stemmed glass on the arcuate section 18 (FIG. 1). Thus an accidental knock to the stemmed glass will not result in it toppling over.

In use, the stemmed glass is held raised above the support position of FIG. 3 and the stem of the glass is passed through the opening 28 (FIG. 1) into the circular opening. The glass is lowered so the cup rests on the arcuate section. It will be appreciated that the size of the opening is dependent on the size of the stem of the stemmed glasses with which the stand will be used and an opening about 23 mm in size has been found to be acceptable for a wide range of glasses currently available. However, it will be understood that fashions change and if stemmed glasses are made with significantly thicker stems then the opening 28 will need to be larger. The opening 28 is sized to allow for easy passage of the stems of most stemmed glasses but is not so large as to unduly reduce the size of the arcuate section 18 upon which the glass rests. The inside diameter of 40 mm of the arcuate section has been chosen to accommodate a wide range of different shape stemmed glasses. Stemmed glasses having an maximum outside diameter less than 40 mm will fall through the opening, but it has been found that few, if any glasses have a smaller outside diameter. Generally the smallest glasses are champagne flutes and most have a diameter of more than 40 mm. The stability of a stemmed glass in the stand reduces as the inside diameter of the arcuate section reduces and a diameter of 40 mm is a suitable compromise to provide sufficient stability for large glasses and to accommodate small stemmed glasses.

The offset 32 between the stake and arcuate sections 12 and 18 is also a compromise. A large offset allows a glass to be placed in and on the stand without the base of the glass touching the stake portion or for the glass to be tipped so the base clears the stake portion. However a large offset means the glass is far away from the stake portion and so in soft or loose soil, such as sand at a beach, the weight of the glass may cause the stand to tip over if the offset is too great. An offset of 55 mm accommodates most stemmed glasses whilst still providing good stability.

It will be appreciated that for simplicity of manufacturing the preferred embodiment is formed merely by bending a single piece of rod and so the opening 28 faces the stake portion 12. If desired a stand according to the invention may be made with the opening not facing the stake portion, which alleviates or overcomes this problem.

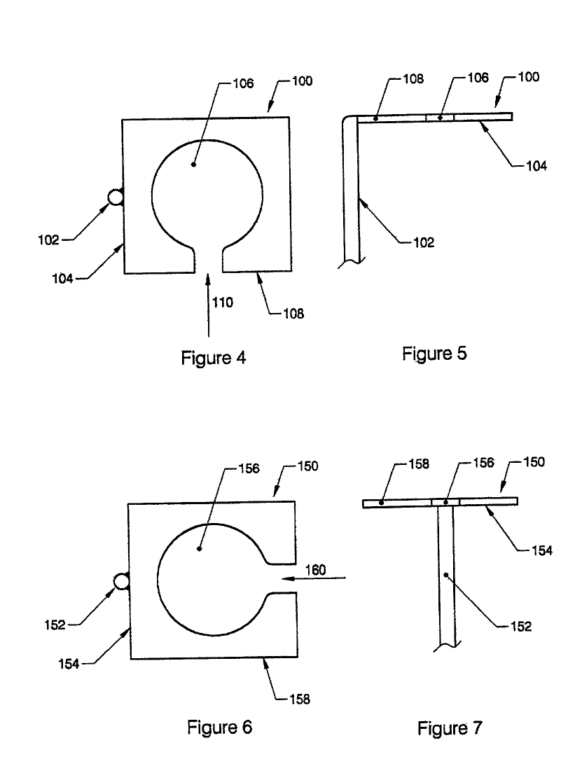

FIGS. 4 and 5 show a stand 100 according to a second embodiment of the invention. The stand is formed with a generally planar support section 104, extending perpendicularly to a stake portion 102. The stand may be formed of material or of plastics material and may be a unitary structure or a made up structure. If made of plastics material, the stand is preferably formed as a unitary structure by injection molding of the plastics material. If made of metal, the stand may be formed of a single pressed and bent metal sheet or made up of a separate stake portion welded to a separate support portion. Other fabrication methods may be used.

The support section 104 has a key hole shaped aperture 106 extending through its thickness and open on a side 108 extending away from the stake portion 102. In this embodiment the glass is moved toward the stand in the direction of arrow 110 and so the stem of the glass is closest to the stake when the glass is supported on the support section, rather than when being moved to the support position.

FIGS. 6 and 7 show a stand 150 according to a third embodiment of the invention. This stand 150 is similar to the second embodiment in having a generally planar support section 154 with a key hole shaped aperture 156. However, in this embodiment the aperture 156 extends to the side 158 furthest from the stake portion 152 and the glass is moved to the support position along arrow 160.

It will be appreciated that the shape of the periphery of the support section is not critical and that other shapes may be used, whether regular or irregular. Similarly the inside shape of the aperture need not be circular, whether the stand is the first, second or third embodiment. To provide stability it is merely necessary for the glass to contact the support section at three or more points; contact at only two points will allow the glass to rock relative to the stand. As such a polygon, such as a triangle rectangle or square etc, may be used as the shape of the internal support surface. Thus, for example, a stand may be formed by bending a single piece of rod similarly to that of FIGS. 1 to 3, but the support section could be bent into a triangular shape, rather than a circular shape.

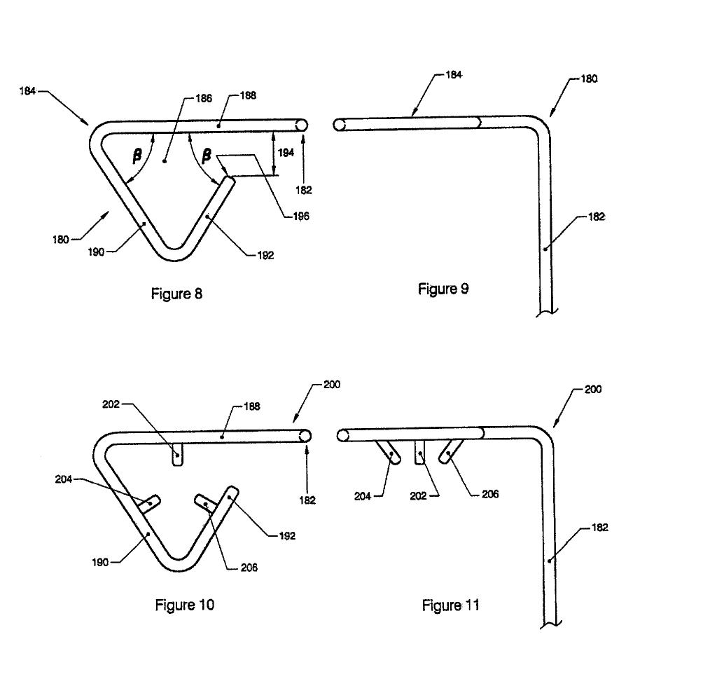

FIGS. 8 and 9 show a stand 180 according to a fourth embodiment of the invention. This stand 180 is formed from a single piece of rod as per the first embodiment with a stake section 182 and a support section 184. However, the support section 184 is not formed with a curved section but is bent into a triangular aperture 186 having legs 188, 190 and 192. The leg 188 is longer than leg 190, so as to provide an offset from the stake portion 182 for the stemmed glasses. The leg 190 is bent at angle β to the first leg 188. This angle is about 45 degrees. The third leg 192 is also bent at the angle β to the first leg so that an equilateral triangle is defined between the three arms for supporting the stemmed glasses. The third leg 192 is shorter than the leg 190 so as to leave an opening 194 between its free end 196 and the first arm 188, through which the stem of a glass may be passed. Because the triangular aperture 186 is equilateral, when a glass is supported on the stand, it will contact all three legs and will be stable.

Whilst the embodiments described generally provide a planar support section, it is to be appreciated that the support section need not be.

FIGS. 10 and 11 show a stand 200 similar to that of FIGS. 8 & 9 and accordingly the same numbers are used for the same parts. The three legs 188, 190 and 192 have three legs 202, 204 & 206 respectively extending from the mid points of the triangular aperture. These legs extend downwards and inwards toward the center of the triangle. This allows the triangle to be larger than otherwise to accommodate large glasses, which will sit on the three horizontal legs 188, 190 & 192. However, small glasses which are too small to sit on the horizontal legs will rest on the angled legs 202, 204 & 206.

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive.

1. A stand for a stemmed drinking implement comprising:
a stake for insertion into the ground; and
a support for engaging and supporting a cup of the drinking implement;
whereby, in use, the drinking implement is raised above the ground.

2. A stand for a stemmed glass comprising:
a base portion for one of attachment and insertion into an object capable of supporting the stand; and
at least one support portion for holding a stemmed glass, the support portion adapted to engage a cup portion of the glass and to hold the glass above the object in a generally upright position.

3. The stand as claimed in claim 2 wherein the base portion is for insertion into the ground.

4. The stand as claimed in claim 3 wherein the base portion includes at least one elongate stake for insertion into the ground.

5. The stand as claimed in claim 2 wherein the at least one support portion extends to one side of the base portion.

6. The stand as claimed in claim 5 wherein the at least one support portion depends from an upper section of the base portion.

7. The stand as claimed in claim 2 wherein the at least one support portion includes two or more support portions, each support portion arranged around the base portion.

8. The stand as claimed in claim 2 wherein each support portion defines at least one engagement surface for resting the cup.

9. The stand as claimed in claim 8 wherein the engagement surface defines a part of a shape selected from the group of shapes consisting of a circle and an equilateral polygon; and
wherein the part of a shape defines a gap to permit the stem of the glass to be passed through the gap.

10. The stand as claimed in claim 8 wherein the engagement surface is defined by one or more rods.

11. The stand as claimed in claim 2 wherein the at least one support portion is generally planar and defines a key hole shaped aperture extending through the plane defined by the support portion;
wherein the aperture having a narrow portion opening on a side of the support portion to allow the stem of the glass to be passed along the narrow portion into the aperture.

12. The stand as claimed in claim 8 wherein the engagement surface defines one of a continuous surface, a series of surfaces, and a series of points for resting the cup.

13. The stand as claimed in claim 12 wherein at least some of said surfaces and points lie in more than one plane.

14. The stand as claimed in claim 12 wherein said surfaces and points define a truncated cone like surface open at both ends and having a vertical slot for engaging different sized glasses.

15. The stand as claimed in claim 8 including a plurality of engagement surfaces comprising one or more primary engagement surfaces defining a primary support laying in a plane and one or more secondary engagement surfaces extending downwardly, relative to said plane when in use, and inwardly from the primary support to accommodate glasses too small to rest on the primary support.

16. The stand as claimed in claim 15 wherein the primary support defines a circle and the engagement surfaces comprise at least three supplemental engagement surfaces.

17. The stand as claimed in claim 15 wherein the primary support defines a polygon and the engagement surfaces comprise a number of supplemental surfaces at least equal to a number of sides of the polygon.

18. The stand as claimed in claim 8 wherein the support portion defining an aperture laying in a plane, said support portion including one or more engagement surfaces extending downwardly, relative to said plane when in use, and inwardly from the edge of the aperture to accommodate glasses of different sizes.

19. A stand for stemmed glasses comprising a single piece of rod formed into an elongate stake portion at one end and a support portion at another end, the support portion extending sideways from a top of the stake portion and bent to define part of one of a circle and an equilateral polygon.
